(19) United States
(12) Patent Application Publication
(10) Pub. No.: US 2006/0285129 A1
(43) Pub. Date: Dec. 21, 2006

(54) Image output apparatus, image input/output system, image capturing apparatus, and program

(76) Inventors: Takehisa Yamaguchi, Ikoma-shi (JP); Akira Fukuda, Suita-shi (JP); Tsutomu Honda, Sakai-shi (JP)

Correspondence Address: SIDLEY AUSTIN LLP, 717 NORTH HARWOOD, SUITE 3400, DALLAS, TX, 75201, US

(21) Appl. No.: 11/360,881

(22) Filed: Feb. 23, 2006

(30) Foreign Application Priority Data
Jun. 21, 2005 (JP) JP2005-180419

(51) Int. Cl. G06K 15/02

(52) U.S. Cl. 358/1.2; 358/302

(57) ABSTRACT

An image output apparatus for outputting an image to an image capturing apparatus comprises a first acquisition part for acquiring information concerning a display resolution of a display of the image capturing apparatus, a change part for changing an output resolution of the image in accordance with the display resolution, and an output part for outputting the image with the output resolution changed by the change part to the image capturing apparatus. The change part changes the output resolution to a resolution lower than an original resolution of the image.

This application is based on application No. 2005-180419 filed in Japan, the contents of which are hereby incorporated by reference.

### BACKGROUND OF THE INVENTION

1. Field of the Invention

The present invention relates to an image output apparatus and a technique associated with the same. In particular, the present invention relates to an image output apparatus for outputting an image to an image capturing apparatus, and a technique associated with the same.

2. Description of the Background Art

An image capturing apparatus has a display part (such as an LCD) on its back face or the like. The display part is mainly used for displaying captured still images and moving images.

It is also considered that a TV broadcast program can be displayed on the display part of the image capturing apparatus. For example, Japanese Patent Application Laid-Open No. 2004-207899 describes the following technique: a TV tuner is connected to an image capturing apparatus and a TV broadcast program received by the TV tuner is displayed on a display part of the image capturing apparatus.

The display part of the image capturing apparatus typically consists of the relatively small number of pixels (e.g., 320×240 pixels). In spite of this fact, in the case of outputting an image of full resolution (e.g., TV broadcast image having horizontal resolution of 525 lines) from the TV tuner to the image capturing apparatus, a transfer amount (communication amount) of image data from the TV tuner to the image capturing apparatus becomes large more than necessary.

There exists a situation such that a user is confused if sound is unexpectedly generated at the time of reproducing a recorded TV image (recorded image) (e.g., at the time of reproducing the recorded image in a commuter train). In order to avoid such a case, it is desired to take some countermeasures.

### SUMMARY OF THE INVENTION

A first object of the present invention is to provide an image output apparatus capable of properly controlling a communication amount on an image, and a technique associated with the same. A second object of the present invention is to provide a technique capable of properly controlling a sound output at the time of reproducing a recorded image.

In order to achieve the first object, according to a first aspect of the present invention, the image output apparatus includes a first acquisition part for acquiring information concerning a display resolution of a display of the image capturing apparatus, a change part for changing an output resolution of the image in accordance with the display resolution, and an output part for outputting the image with the output resolution changed by the change part to the image capturing apparatus. Herein, the change part changes the output resolution to a resolution lower than an original resolution of the image.

The image output apparatus can prevent a communication amount related to an image from increasing more than necessary, and properly control the communication amount related to an image.

Further, the present invention is also directed to an image input/output system and a program product.

In order to achieve the second object, according to a second aspect of the present invention, an image capturing apparatus includes a display for reproducing and displaying an image, a speaker capable of outputting sound related to the image, and a controller for determining whether an image to be reproduced is an image captured by the image capturing apparatus or a recorded image obtained by recording an image input to the image capturing apparatus and, when the image to be reproduced is determined as the recorded image, performing control so as not to output a sound output related to the image to be reproduced from the speaker.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a schematic configuration of an image input/output system according to a first preferred embodiment;

FIG. 2 is a schematic diagram which illustrates an internal configuration of a digital camera;

FIG. 3 is a schematic diagram which illustrates an internal configuration of a cradle;

FIG. 4 is a flowchart which illustrates operations in the system;

FIG. 5 is a flowchart which illustrates operations in the system;

FIG. 6 is a flowchart which illustrates viewing operations by the digital camera;

FIG. 7 illustrates a configuration of a file to be reproduced;

FIG. 8 is a flowchart which illustrates operations according to a modification;

FIG. 9 illustrates a schematic configuration of a system according to another modification; and

FIG. 10 illustrates a schematic configuration of a system according to still another modification.

### DESCRIPTION OF THE PREFERRED EMBODIMENTS

Hereinafter, preferred embodiments of the present invention will be described with reference to the drawings.

(A. Outline of System)

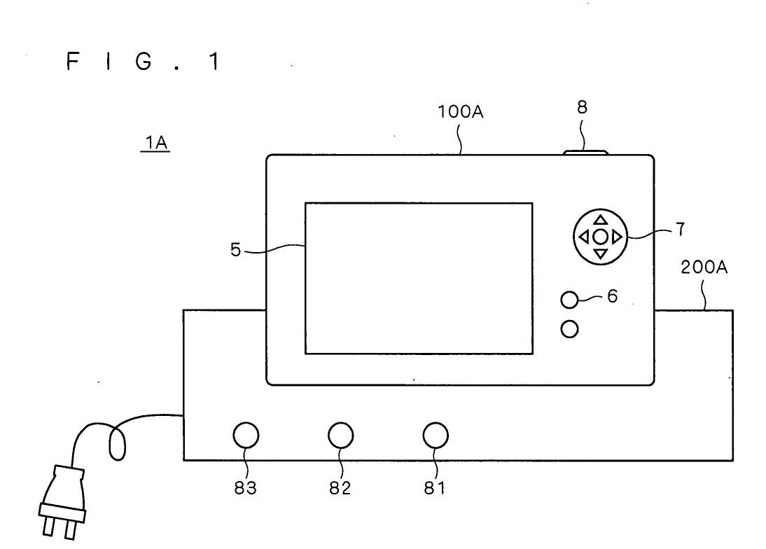

FIG. 1 is an appearance view which illustrates an image input/output system 1A according to a preferred embodiment.

The image input/output system 1A includes a digital camera (image capturing apparatus) 100A and a cradle (also referred to as “dock”) 200A. The digital camera 100A is attachable to/detachable from the cradle 200A. FIG. 1 illustrates a state where the digital camera 100A is attached to the cradle 200A.

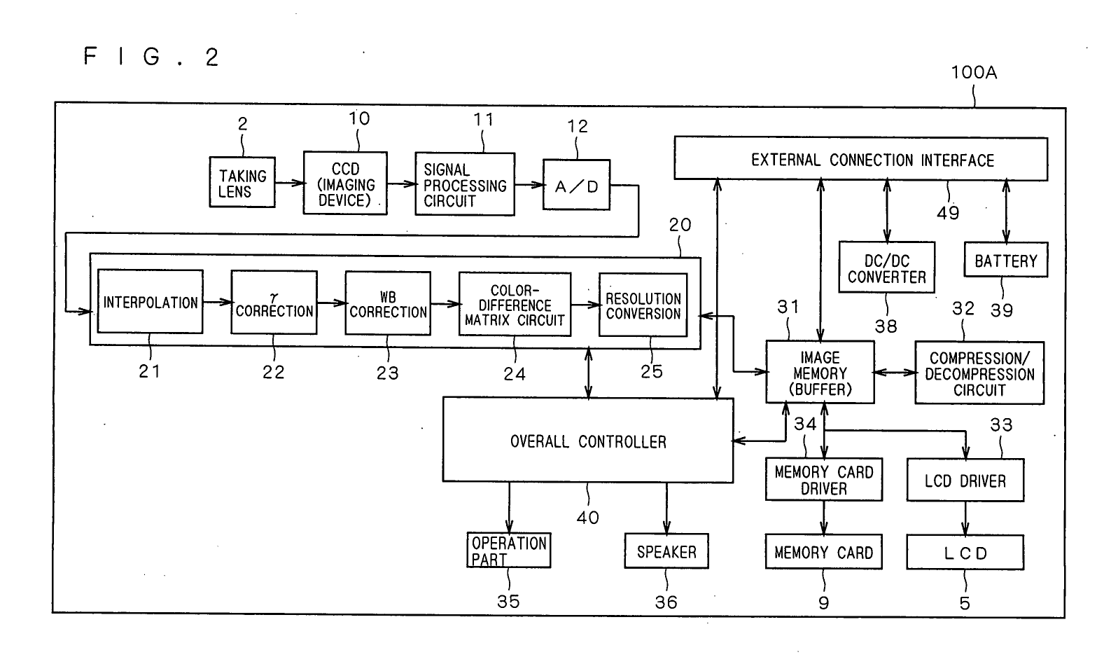

The digital camera 100A has a liquid crystal display (hereinafter, simply referred to as “LCD”) 5 on its back face side, and a taking lens 2 (see FIG. 2) on its front face side. The LCD 5 is a display part consisting of the predetermined number of pixels (e.g., 320×240 RGB pixels). The digital camera 100A also has a shutter release button 8 on its top face side. The shutter release button 8 takes a form of a two-level switch capable of detecting a half-pressed state S1 and a full-pressed state S2.

The digital camera 100A can capture a still image of a subject. When the shutter release button 8 is pressed in a still-image capturing mode such that the digital camera 100A enters the full-pressed state S2, a still image of the subject can be captured. The digital camera 100A also has a moving-image capturing function. When the shutter release button 8 is pressed in a moving-image capturing mode, a moving image of the subject can be captured. A recording resolution at the time of capturing a moving image in the moving-image capturing mode is set to a set value selected by an operator from among plural set values such as 640×480 pixels, 320×240 pixels and 160×120 pixels.

Further, the digital camera 100A can reproduce and display a captured image (still image or moving image) on the LCD 5.

In addition to the aforementioned image capturing functions, the digital camera 100A can display an image (TV image, DVD image or the like) received from the cradle 200A on the LCD 5, record the received image, and charge a battery (also referred to as “rechargeable battery” or “secondary battery”) 39 provided inside the digital camera 100A by power supply from the cradle 200A. These functions (the function of displaying an image received from the cradle 200A, the function of recording the received image, and the function of charging the battery 39, and the like) are valid in a state where the digital camera 100A is connected to the cradle 200A.

The cradle 200A has a TV picture receiving function (so-called a TV tuner function) and has a function of outputting a received image to the digital camera 100A. The cradle 200A can output not only a TV picture but also a picture from an image reproducing apparatus (such as a DVD player) connected to the cradle 200A to the digital camera 100A. Alternatively, a picture from an image reproduction part (such as DVD player part) incorporated in the cradle 200A may be output to the digital camera 100A.

As described above, the cradle 200A also functions as an image output apparatus for outputting an image to the digital camera 100A.

On a lower side of the cradle 200A, various lamps 81, 82 and 83 are provided for respectively showing an operation state of the cradle 200A. More specifically, the receiving-state lamp 81 indicates a state where a TV broadcast program is being received, the recording-state lamp 82 indicates a state where a TV broadcast program is being recorded, and the charging-state lamp 83 indicates a state where the digital camera 100A is being charged.

In the following, the detailed configuration of the digital camera 100A and that of the cradle 200A will be sequentially described.

(B. Digital Camera)

First, the configuration of the digital camera 100A will be described with reference to FIG. 2. FIG. 2 is a schematic diagram which illustrates an internal configuration of the digital camera 100A.

A CCD imaging device (hereinafter, simply referred to as “CCD”) 10 functions imaging means for capturing an image of a subject to generate an electronic image signal. The CCD 10 has the predetermined number of pixels (e.g., about 3,000,000 pixels), photoelectrically converts a light image of the subject formed by the taking lens 2 into an image signal (signal including a signal train of pixel signals received by the pixels) of color components of R (red), G (green) and B (blue) pixel by pixel, and outputs the resultant image signal.

The image signal obtained from the CCD 10 is supplied to a signal processing circuit 11 where the image signal (analog signal) is subjected to a predetermined analog signal processing. The signal processing circuit 11 has a correlated double sampling (CDS) circuit and an auto gain control (AGC) circuit. The signal processing circuit 11 performs a process for reducing noise in the image signal by the CDS circuit and adjusts the gain by the AGC circuit, thereby adjusting the level of the image signal.

An A/D converter 12 converts each of the pixel signals (analog signals) of the image signal into a digital signal of the predetermined number of bits (herein, 12 bits). The A/D converter 12 converts each of the pixel signals (analog signals) into a 12-bit digital signal on the basis of clocks for A/D conversion supplied from an overall controller 40.

The resultant digital image signal is input to an image processing circuit 20.

The image processing circuit 20 has an interpolation circuit 21, a γ (gamma) correction circuit 22, a WB (white balance) circuit 23, a color-difference matrix circuit 24, and a resolution conversion circuit 25.

The interpolation circuit 21 performs an interpolating process on the pixels. Since each of the pixels of the CCD 10 has information of only one of primary color components of R, G and B, the interpolation circuit 21 performs an interpolating process of estimating information of other primary color components on the basis of the values of peripheral pixels.

The γ correction circuit 22 corrects tone of pixel data, and the WB circuit 23 converts the level of each of the color components of R, G and B.

The color-difference matrix circuit 24 has a Y matrix, a Cr matrix and a Cb matrix as matrixes for conversion. The color-difference matrix circuit 24 has the function of converting color information expressed in a color space (RGB color space) having the primary color components of R, G and B into color information expressed in a color space (YCrCb color space) having a brightness component (Y) and color-difference components (Cr and Cb). As digital data obtained by the conversion, digital data of the YCC (4:1:1) form (data form in which the ratio of data amounts (resolution) of Y component, Cr component and Cb component is 4:1:1) is employed. The present invention is not limited to the data. Data of the YCC (4:2:2) form (data form in which the ratio of data amounts (resolution) of the Y component, the Cr component and the Cb component is 4:2:2) may be also employed.

The resolution conversion circuit 25 has the function of performing predetermined resolution conversion on the image data acquired from the CCD 10. The resolution conversion circuit 25 operates mainly at the time of generating a captured image and a live image. As will be described later, an image from the cradle 200A is preliminarily subjected to resolution conversion. Consequently, at the time of recording an image from the cradle 200A, the resolution conversion circuit 25 does not have to operate.

The image signal input to the image processing circuit 20 is subjected to proper processes by the respective circuits 21 to 25, and the resultant is stored as image data in an image memory 31 serving as a buffer.

The image memory 31 is a memory for temporarily storing image data acquired by the CCD 10 at the time of the image capturing operation and subjected to the image processes.

When a recording instruction (image capturing instruction) is given from the user, image data is transferred from the image memory 31 to a memory card 9 and recording of the image data is performed. Concretely, the image data stored in the image memory 31 is read by a compression/decompression circuit 32 and, then, is compressed in accordance with a predetermined compressing method, and the compressed image data is written again into the image memory 31. Further, after that, based on the drive control of a memory card driver 34, the image data is read from the image memory 31, transferred to the memory card 9, and written in the memory card 9. These operations are controlled in a centralized manner by the overall controller 40. As the compressing method, the method such as JPEG is used at the time of capturing a still image and the method such as MPEG (specifically, MPEG1, MPEG2, or MPEG4), Motion JPEG or the like is used at the time of capturing a moving image.

Aside from an image to be recorded, an image for live view is generated and displayed on the LCD 5 via an LCD driver 33, and a live view display is performed.

The digital camera 100A can also reproduce the captured image (still image or moving image). Image data to be reproduced, which is stored in the memory card 9, is read from the memory card 9 and stored in the image memory 31 and decompressed by the compression/decompression circuit 32. After that, resolution conversion is performed by the resolution conversion circuit 25 if necessary, and the resultant image is displayed on the LCD 5. Audio data included in the image data is output as sound from a speaker 36.

Further, as described above, the digital camera 100A can display and record an input image (stream data) from the cradle 200A.

Specifically, an image received from the cradle 200A is temporarily stored in the image memory 31 and, after that, read from the image memory 31. After that, the image is displayed on the LCD 5 via the LCD driver 33 and/or is transferred to the memory card 9 via the memory card driver 34 to be written in the memory card 9. Since an image received from the cradle 200A is already subjected to the resolution conversion on the cradle 200A side, it is unnecessary to perform the resolution conversion on the digital camera 100A side. In particular, since the resolution of a transferred image (input image) is converted in advance into resolution lower than resolution (original resolution) of an original image in a TV broadcast program, the amount of data transferred from the cradle 200A to the digital camera 100A (communication amount) can be reduced.

More specifically, an image received from the cradle 200A and temporarily stored in the image memory 31 is subjected to a required converting process (e.g., a process of converting the form of YCC (4:2:2) into the form of YCC (4:1:1)). After that, the image is read from the image memory 31 and transferred to the LCD 5 and/or the memory card 9. The present invention is not limited to the above. Alternatively, data of the form (e.g., the form of the YCC (4:1:1)) which is the same as that after conversion by the color-difference matrix circuit 24 in the digital camera 100A may be transferred from the cradle 200A toward the digital camera 100A. In this case, the converting process on the digital camera 100A side is unnecessary, so that efficiency further improves.

The digital camera 100A also has a recording programming function. The operator can set programming of recording with the use of a recording programming screen or the like. The recording programming screen is displayed on the LCD 5 by operation on a menu button 6 and a control button 7. By operating the control button 7, the operator can set items (concretely, recording start time, recording end time, and recording channel) in the recording programming screen.

The digital camera 100A has a DC/DC converter 38. In the case of receiving power supply from the cradle 200A, power is supplied to the processors in the digital camera 100A via the DC/DC converter 38. Consequently, failure in recording due to exhaustion of a battery can be avoided, and the user does not have to mind the remaining quantity of the battery 39 (to be described below).

The digital camera 100A also has the battery 39 incorporated therein. In the case where power supply from the cradle 200A is not received, power is supplied to various circuits in the digital camera 100A from the battery 39. As will be described later, the battery 39 can be charged in accordance with power supply from the cradle 200A.

An external connection interface (IF) 49 has the function of connecting the digital camera 100A and the cradle 200A to each other to realize desired data communication. The data communication is performed by digital data.

The external connection IF 49 takes a form of a communication interface conformed with, for example, the USB standard. As will be described later, via the external connection IF 49, for example, stream data from the cradle 200A can be received, various control data can be transmitted to/received from a controller 70 of the cradle 200A, and power supply from the cradle 200A can be received. The external connection IF 49 is not limited to a communication interface conformed with the USB standard. Alternatively or additionally, a communication interface conformed with any of various standards (e.g., unique standard) may be used.

An operation part 35 is an operation part including the menu button 6 (see FIG. 1), the control button 7 and the shutter release button 8, and is a member for operating settings of the digital camera 100A by the user.

The overall controller 40 is constructed by a microcomputer having therein a RAM and a ROM, and functions as control means for executing a predetermined control program by the microcomputer, thereby controlling the components in a centralized manner.

(C. Cradle)

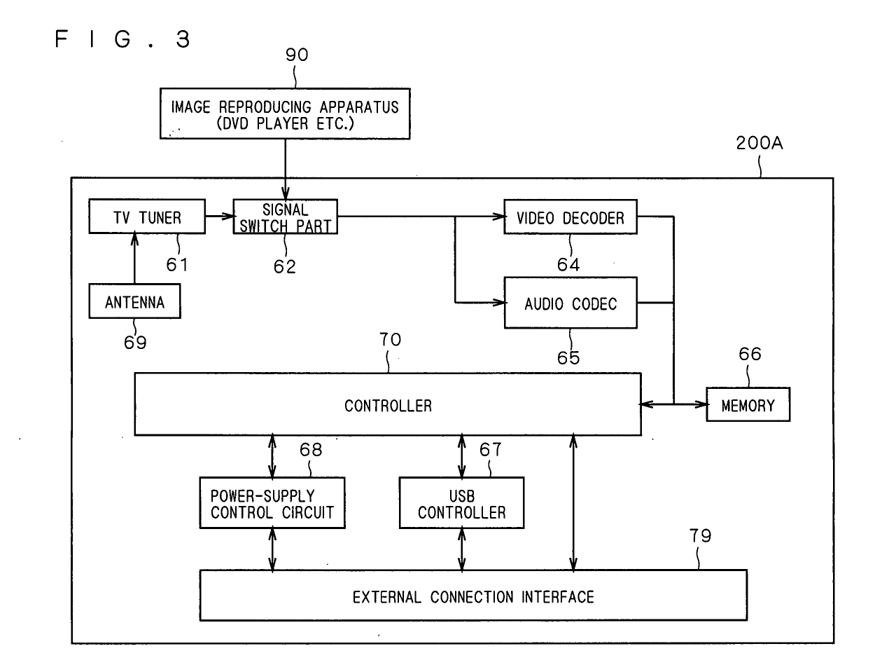

Next, the configuration of the cradle 200A will be described with reference to FIG. 3. FIG. 3 is a schematic diagram which illustrates an internal configuration of the cradle 200A.

The cradle 200A can output an image (e.g., TV image or DVD image) to the digital camera 100A.

The cradle 200A includes a TV tuner 61, a signal switch part 62, a video decoder 64, an audio codec 65, a memory 66, a USB controller 67, a power supply control circuit 68, an antenna 69, and the controller 70.

The TV tuner 61 has the function of generating an image signal (TV image) on the basis of TV broadcast waves received by the antenna 69.

The cradle 200A has an external video input terminal and an external audio input terminal (not illustrated), and can receive image signals (including a video signal and an audio signal) from an image reproducing apparatus 90 such as a DVD player. The signal switch part 62 has the function of switching, as an image to be output to the digital camera 100A, between a TV image and an image from the image reproducing apparatus.

The image signal selected by the signal switch part 62 is separated into the video signal and the audio signal which are input to the video decoder 64 and the audio codec 65. Concretely, the video signal in an image signal output from the signal switch part 62 is input to the video decoder 64, while the audio signal in the image signal is input to the audio codec 65.

The video decoder 64 converts the video signal of an input analog signal to digital data. As the digital data (video signal) obtained by the conversion, for example, digital data in the form of YCC (4:2:2) can be employed. The present invention is not limited to the data but data in the form which is the same as data obtained by conversion of the color-difference matrix circuit 24 in the digital camera 100A, concretely, the form of YCC (4:1:1) may be employed.

The audio codec 65 converts the audio signal of the input analog signal into digital data. As the digital data (audio signal) obtained by conversion, for example, digital data in the PCM (Pulse Code Modulation) form can be employed.

The video decoder 64 also has the function of converting the resolution of the input image signal (specifically, the video signal). For example, the video decoder 64 can convert a video signal having horizontal resolution of 525 lines into a signal having horizontal resolution of 240 lines which is the same as that of the LCD 5. In such a manner, the output resolution of an image output from the cradle 200A can be converted. Although the case where the video decoder 64 also performs resolution conversion is described herein as an example, it is also possible to convert the resolution by a resolution conversion circuit which is separately provided.

The digital data (video signal and audio signal) generated by the video decoder 64 and the audio codec 65 is temporarily stored in the memory 66 and, after that, transmitted as image data (also referred to as “moving image data” or “streaming data”) to the digital camera 100A via an external connection interface (IF) 79. The transmitting operation is controlled by the USB controller 67 and the controller 70.

The external connection IF 79 takes a form of a communication interface conformed with, for example, the USB standard. By the communication between the external connection IF 79 and the external connection IF 49, for example, streaming data can be transmitted to the digital camera 100A, various control data can be transmitted to/received from the overall controller 40 of the digital camera 100A, and power can be supplied to the digital camera 100A. The external connection IF 79 is not limited to a communication interface conformed with the USB standard. Alternatively or additionally, a communication interface conformed with any of various standards (e.g., unique standard) may be used.

The controller 70. is constructed by a microcomputer having therein a RAM and a ROM, and functions as control means for executing a predetermined control program by the microcomputer, thereby controlling the components in a centralized manner.

The cradle 200A receives power supply from a household AC power source (AC receptacle). The cradle 200A converts the supplied AC voltage to DC voltage by the AC/DC converter in the power supply control circuit 68. After that, the cradle 200A can supply the converted voltage to the processors in the cradle 200A and, also, supply it to the digital camera 100A.

The power supply control circuit 68 controls the operation of supplying power to the digital camera 100A (more specifically, operation of charging the battery 39 in the digital camera 100A) in cooperation with the controller 70.

The cradle 200A and the digital camera 100A can transmit/receive various kinds of information by communications via the external connection IFs 79 and 49.

Examples of information to be transmitted/received are (1) information concerning the LCD 5 in the digital camera 100A (such as display resolution of the LCD 5), (2) information concerning moving image recording (such as recording resolution, image quality (compression ratio), and the like of a moving image) in the digital camera 100A, (3) information (such as unused storage capacity (remaining capacity) and write speed) concerning the memory card 9, (4) information concerning recording (such as recording start time, recording end time, a channel, and an image source (TV image or DVD image)), (5) time information of a internal clock in the digital camera 100A and that in the cradle 200A, and (6) various control instructions (charging start instruction, charging end instruction, recording start instruction, recording end instruction and the like).

(D. Operations of Displaying/Recording TV Program etc.)

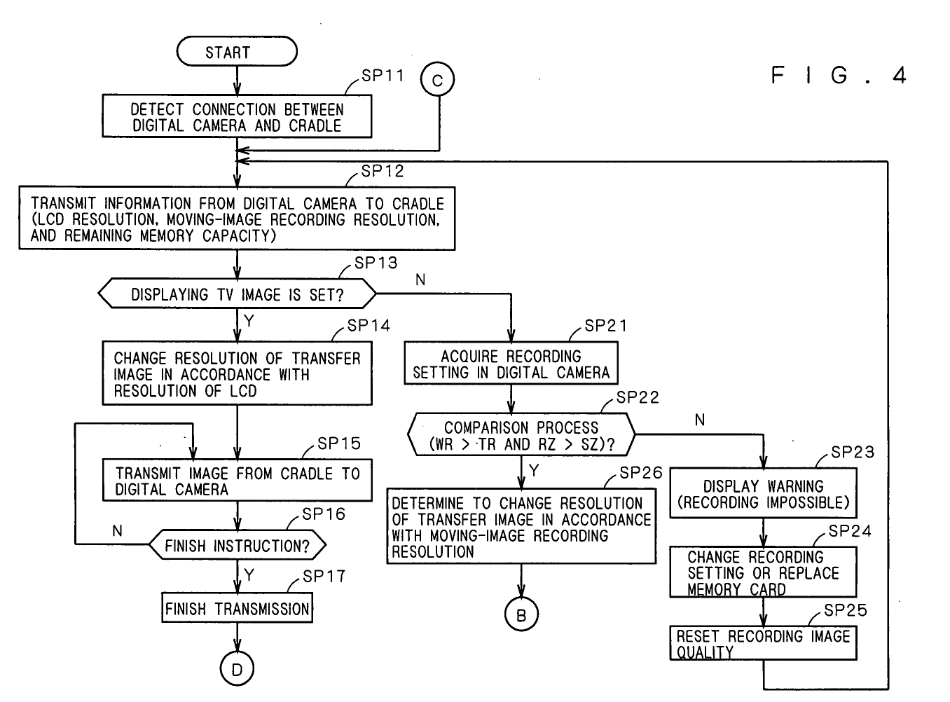

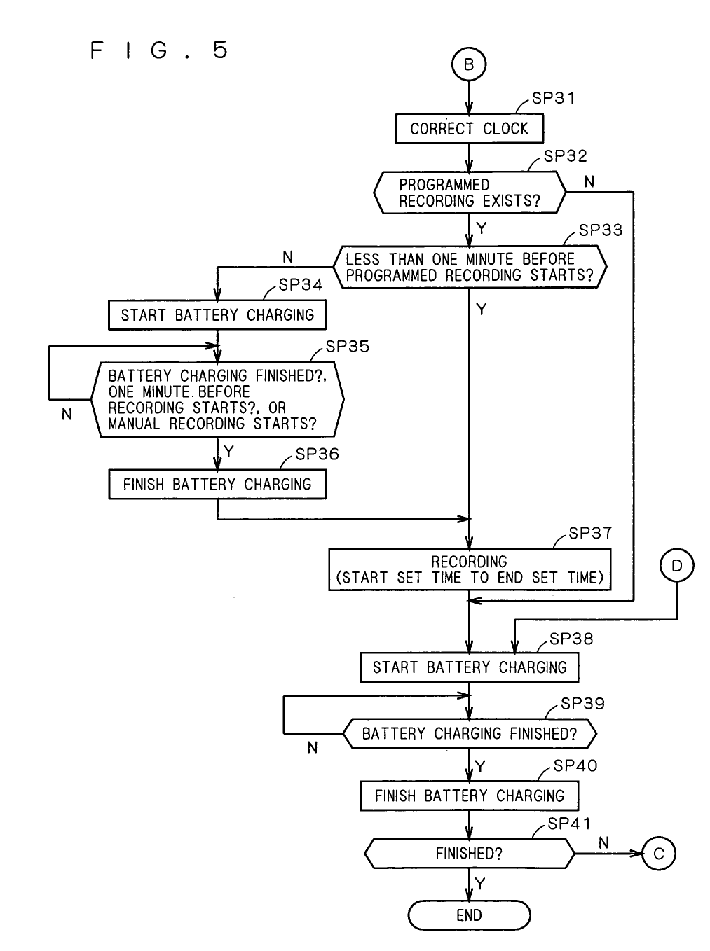

FIGS. 4 and 5 are flowcharts which illustrate operations of the system 1A when the digital camera 100A and the cradle 200A are connected to each other. When the digital camera 100A and the cradle 200A are connected to each other, operations of displaying and recording an image received from the outside of the digital camera 100A, such as a TV image and a DVD image (hereinafter, also referred to as “external input image”) can be executed. In the following, the case where a TV image as an external input image is output from the cradle 200A to the digital camera 100A is assumed. The case where another external input image such as a DVD image is output from the cradle 200A to the digital camera 100A is similar to the assumed case. In this preferred embodiment, it is assumed for the sake of simplification of description that the case where display and recording of an external input image (such as a TV image) are not performed simultaneously.

First, when connection between the digital camera 100A and the cradle 200A is detected by both of the digital camera 100A and the cradle 200A (step SP11), various kinds of information are transmitted from the digital camera 100A to the cradle 200A (step SP12). Concretely, information concerning the LCD 5 (such as display resolution or the like of the LCD 5) of the digital camera 100A, information concerning moving-image recording (such as recording resolution, image quality (compression ratio), and the like of a moving image) in the digital camera 100A, and information (such as unused storage capacity (remaining capacity) and write speed) concerning the memory card 9 is transmitted from the digital camera 100A to the cradle 200A.

Next, the cradle 200A determines whether or not displaying a TV image (external input image) is set in the digital camera 100A (step SP13).

When it is determined that displaying a TV image is set, the cradle 200A changes the resolution of an image (transfer image) transferred to the digital camera 100A in accordance with the display resolution of the LCD 5. For example, when the display resolution of the LCD 5 is 320×240 pixels, the resolution of an external input image to be transferred to the digital camera 100A is set to the same resolution (i.e., 320×240 pixels) as that of the LCD 5. After the setting operation, the video decoder 64 of the cradle 200A converts a TV image signal having horizontal resolution of 525 lines into a signal having horizontal resolution of 240 lines which is the same as that of the LCD 5. The digital data obtained by conversion is transferred from the cradle 200A to the digital camera 100A (step SP15). The digital camera 100A temporarily stores, in the image memory 31, an input image transferred from the cradle 200A, after that, transfers it to the LCD 5 via the LCD driver 33, and displays it on the LCD 5. Such an operation of displaying an external input image is continued until an end instruction is given by the operator and is finished in response to the end instruction (steps SP16 and SP17). After that, charging of the battery starts (step SP38).

On the other hand, when it is determined that displaying a TV image is not set, the cradle 200A will perform a recording operation or the like.

Concretely, first, in step SP21, the cradle 200A acquires recording settings in the digital camera 1 00A through communication with the digital camera 100A. To be specific, the cradle 200A acquires the presence/absence of programmed recording and the details of the programmed recording (recording start time, recording end time, a channel to be recorded, and the like).

In step S22, it is determined whether or not the present recording settings exceed the recording capability (image recording capability) of the memory card 9. When there is no programmed recording, the program goes to SP26 without performing the determining operation.

Concretely, write speed WR and remaining capacity RZ of the memory card 9 acquired in step SP12 are compared with image rate TR and assumed file size SZ, respectively. The image rate TR is an information amount per unit time of an image (recording image) generated at the time of recording, and is calculated on the basis of set values (concretely, resolution PR and image quality PQ (compression ratio) at the time of recording a moving image) acquired in step SP12. The assumed file size SZ is calculated on the basis of the image rate TR and a recording time (=end time−start time).

When the remaining capacity RZ of the memory card 9 is smaller than the assumed file size SZ, recording cannot be continued until the end time. When the write speed WR of the memory card 9 is lower than the image rate TR, recording cannot be executed accurately. In these cases, therefore, it is determined that the present recording settings exceed the recording capability (image recording capability) of the memory card 9. A warning message indicating that it is impossible to properly execute recording is displayed on the LCD 5 (step SP23). In response to the warning message, the operator changes the memory card to a memory card having larger remaining capacity or changes the setting of resolution and/or image quality at the time of the moving image recording. After that, the program returns again to step SP12 and similar operations are performed again. In the case where the operation of changing the setting on the moving image recording, the changed setting is set in the digital camera 100A (step SP25).

On the other hand, when the remaining capacity RZ of the memory card 9 is larger than the assumed file size SZ and the write speed WR of the memory card 9 is higher than the image rate TR, it is determined that the present recording settings do not exceed the recording capability (image recording capability) of the memory card 9 and there is no problem with the recording parameters, and the program goes to step SP26. It is also possible to construct so that the program goes to step SP23 or SP26 when WR=TR and/or RZ=SZ in the comparison process in step SP22.

In such a manner, a check is made to see whether or not recording can be programmed (steps SP21 to SP25). Although the case of making a check to see whether or not recording can be programmed mainly by the cradle 200A is described here as an example, the present invention is not limited to the case. A check to see whether or not recording can be programmed may be made mainly by the digital camera 100A.

In step SP26, the cradle 200A sets the output resolution of an image to be output to the digital camera 100A to the same value as the resolution (set value) PR in the moving image recording. The resolution PR in the moving image recording is set to a set value which is selected by the operator from among plural set values such as 640×480 pixels, 320×240 pixels and 160×120 pixels. The output resolution is set to the same value as such a set value. When the resolution PR is set by the operator to resolution (e.g., 640×480 pixels) higher than that of the LCD 5, the resolution PR is reset to resolution (e.g., 320×240 pixels) which is equal to or less than the resolution of the LCD 5, and the output resolution is set to the same value as the reset resolution PR.

In such a manner, the cradle 200A outputs an image having a preliminarily converted resolution to the digital camera 100A at the time of recording which will be described later. In particular, in the case of recording an image having a resolution lower than that of a source image (TV image) (e.g., in the case of converting a TV video signal having horizontal resolution of 525 lines to a signal having horizontal resolution of 240 lines which is the same as the horizontal resolution of the LCD 5), an image having a preliminarily lowered resolution is generated on the cradle 200A side, and the resultant image is transferred to the digital camera 100A, so that there is no waste.

In step SP31, a clock correcting operation is performed. Concretely, time of the internal clock in the digital camera 100A and time of the internal clock in the cradle 200A are compared with each other. If the difference between the times is less than three minutes, one of the times is adjusted to the other time. Herein, the time of the digital camera 100A is changed in accordance with the time of the cradle 200A. On the other hand, if the difference is three minutes or more, the cradle 200A displays, on the LCD 5, a warming message indicating that the clock has to be adjusted, and waits for an input of time from the operator. When the time is input from the operator, the time of the digital camera 100A is changed in accordance with the time input from the operator and transferred from the digital camera 100A to the cradle 200A, and the time of the cradle 200A is also changed according to the time input from the operator.

After that, the cradle 200A determines whether or not recording programming exists in step SP32. If YES, the cradle 200A further determines whether or not the time that elapses before programmed recording start time is less than one minute in step SP33. Based on the result of determination, a battery charging operation and a recording operation are adjusted.

In the case where no recording programming exists, the battery charging operation (steps SP38 to SP40) of the digital camera 100A is performed promptly. Concretely, the cradle 200A transmits a message indicating that charging of the battery starts to the digital camera 100A, supplies power to the digital camera 100A, and starts the battery charging operation of charging the battery 39 of the digital camera 100A (step SP38). When a percentage of the battery charging reaches a predetermined value, the battery charging operation is finished (steps SP39 and SP40).

In the case where recording programming whose programmed recording start time starts within one minute exists, without performing the battery charging operation (steps SP34 to SP36) at least at that time point, program goes to step SP37 where recording operation is performed.

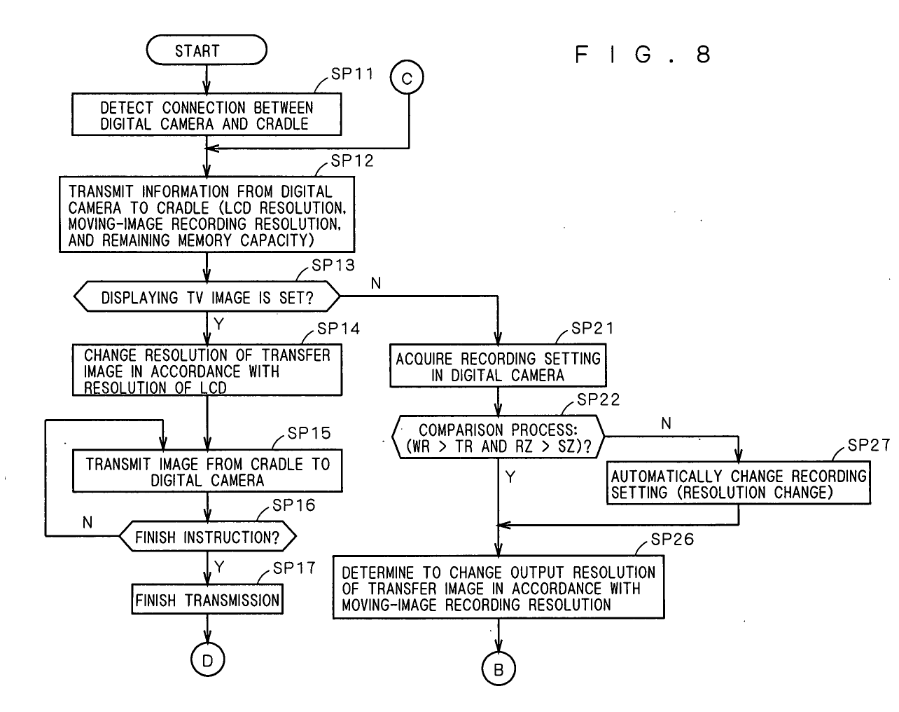

In step SP37, concretely, the cradle 200A performs resolution conversion and the like on a TV image (digital data) of a channel to be programmed during the period from the time just before start time (e.g., 10 seconds before) until the end time, and transfers the resultant TV image to the digital camera 100A. When the start time comes, the digital camera 100A starts recording the TV image. When the end time comes, the digital camera 100A finishes recording of the TV image. Identification information DM (see FIG. 7) indicating that the image file is an image file recorded by the system 1A (in other words, a file in which image signals output from the cradle 200A are recorded) is given to an image file (recorded image file) GF generated by the recording operation,. Concretely, the identification information DM is added into tag information TG in the image file (recorded image file) GF. The identification image DM is not added to a “captured image” (which will be described later) captured by the digital camera 100A.

On the other hand, in the case where recording programming whose programmed recording start time starts within one minute does not exist, the battery charging operation (steps SP34 to SP36) is performed. Concretely, the cradle 200 sends a notification indicating that the battery charging operation starts to the digital camera 100A, and starts the battery charging operation (step SP34). When a percentage of the battery charging reaches a predetermined value, the battery charging operation is finished (steps SP35 and SP36), and the program goes to step SP37. When there is recording programming and, at one minute before the scheduled start time, the battery charging operation is interrupted (steps SP35 and SP36), and the program goes to step SP37. Further, also when manual recording operation using the digital camera 100A is performed, the battery charging operation is finished (steps SP35 and SP36), and the program goes to step SP37.

In step SP37, recording operation is performed. At the time of programmed recording, the recording operation as described above is performed.

In the manual recording operation, recording starts at the time point of the recording starting operation. More specifically, when recording data is transmitted from the digital camera 100A to the cradle 200A, the cradle 200A sets a channel in accordance with the recording data, and transfers a TV image having a resolution converted into resolution that is preliminarily determined in step SP26 to the digital camera 100A. The digital camera 100A records the. TV image transferred from the cradle 200A. The recording operation is continued until the recording end time which is set in the manual recording operation, the time point when the manual recording finishing operation is performed, or the time point when the unused storage capacity of the memory card 9 becomes zero and, after that, finished. Also to a picture file obtained by the manual recording, the identification information DM is added in a manner similar to the image file obtained by programmed recording.

After completion of the recording operation, the battery charging operation (steps SP38 to SP40) is performed. In the case where the battery operation is interrupted once before recording, the battery charging operation which has not been completed before recording restarts and completes. Although the case of determining only whether or not the battery charging operation is finished in step SP39 is described here as an example, the present invention is not limited to the case. Alternatively, it may be determined whether or not it is one minute before recording start time of the next recording programming and whether or not manual recording starts in step SP39. If it is one minute before recording start time or manual recording starts, the program may return to step SP37 (or step SP12).

In step SP41, the end is determined. When there is no recording programming and a no-operation state continues for predetermined time (e.g., three minutes), the program is finished. On the other hand, when the program should not be finished such as the case where recording programming remains, the program returns again to step SP12 and repeats the operations.

As described above, the battery charging operation, the recording operation and the like (steps SP32 to SP41) are performed. Although the case of determining priorities between the recording operation and the battery charging operation mainly by the cradle 200A is described above as an example, the present invention is not limited to the case. Alternatively, the priorities or the like may be determined mainly by the digital camera 100A. In this case, in steps SP34, SP36, SP38 and SP40, a start instruction and an end instruction of battery charging are transmitted from the digital camera 100A to the cradle 200A. According to the instructions, power supply from the cradle 200A to the digital camera 100A may be started or stopped.

In the aforementioned operations, the output resolution of a TV image is reduced in advance in the cradle 200A in accordance with the display resolution of the LCD 5. Consequently, the amount of communication between the cradle 200A and the digital camera 100A can be prevented from increasing excessively. That is, the communication amount in image data transfer from the cradle 200A to the digital camera 100A can be controlled properly.

In the aforementioned operation, at the time of recording in the digital camera 100A, it is controlled so that the battery 39 is not charged. That is, the power supply control circuit 68 controls so that the charging of the battery 39 and the recording operation are not performed at the same time. In other words, the battery 39 is not charged at least during recording of an image in the digital camera 100A. Consequently, the cradle 200A does not have to have relatively large power source capacity for simultaneously performing charging of the battery 39 and the recording operation. It is sufficient for the cradle 200A to have relatively small power source capacity for performing either the charging of the battery 39 or the recording operation. That is, as compared with the case where recording and charging are performed at the same time, the power source capacity of the cradle 200A can be made relatively small.

(E. Operation of Viewing Recorded TV Program etc.)

Next, an operation of viewing various images by the digital camera 100A will be described. As kinds of images to be viewed, a TV image or the like recorded by the system 1A (hereinafter, also referred to as “recorded image”) and an image (still image or moving image) captured via the taking lens 2 of the digital camera 100A (hereinafter, also referred to as “captured image”) exist.

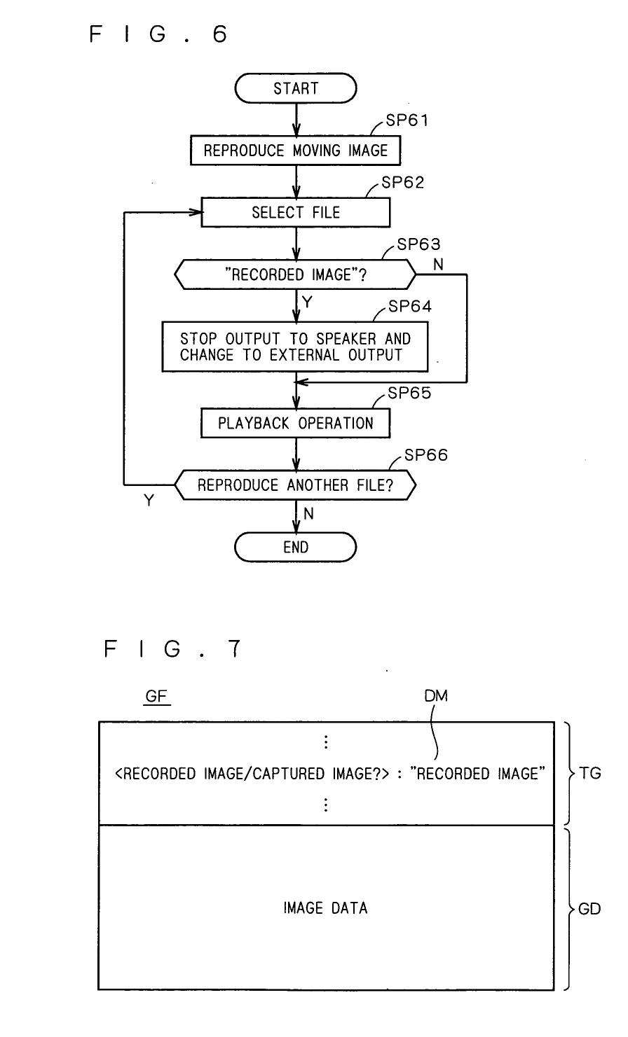

FIG. 6 is a flowchart which illustrates the viewing operation. The “recorded image” and the “captured image” stored in the memory card 9 can be reproduced by the digital camera 100A. In particular, in the case where the digital camera 100A is used in a state where it is separated from the cradle 200A, the image can be viewed in various places by utilizing the portability of the digital camera 100A. For example, a recorded image and a captured image can be viewed at a place away home, in a car traveling, or the like.

First, a playback mode (or moving image playback mode) is detected (step SP61), a file list is displayed on the LCD 5 of the digital camera 100A, and a desired file is selected as a file to be reproduced by the operator from the file list (step SP62).

Next, the digital camera 100A determines whether the file to be reproduced is a recorded image or a captured image (step SP63). Concretely, with reference to the tag information TG in the file to be reproduced, the image (image data GD) included in the file to be reproduced is either a recorded image or a captured image is determined depending on whether or not the identification information DM (see FIG. 7), indicating that the image is an image received from the cradle 200A, is included in the tag information TG.

In the case where the file to be reproduced is determined as a “captured image”, the program goes to step SP65 where the digital camera 100A (overall controller 40) reproduces the file to be reproduced. In the case where audio data is included in the file to be reproduced, sound is output from the speaker 36.

On the other hand, when the file to be reproduced is determined as a “recorded image”, the overall controller 40 stops sound output from the speaker 36, and controls so that an audio signal is output from the headphone terminal of the digital camera 100A (step SP64) and, after that, the program goes to step SP65 where the file to be reproduced is reproduced.

There are circumstances such that the “recorded image” is often reproduced to be viewed by a person in a commuter train or the like. By the operation as described above, sound can be prevented from being unintentionally output from the speaker 36 at the time of viewing such a recorded image (e.g., in a commuter train or the like). That is, the sound output at the time of reproducing a recorded image can be properly controlled.

On the other hand, there are circumstances such that the “captured image” is reproduced so as to be viewed by a plurality of people. By the operation as described above, sound is output from the speaker 36 at the time of viewing such a captured image, so that it is suitable for viewing by a plurality of people.

Also in the case where the file to be reproduced is changed after that (step SP66), similar operations (steps SP62 to SP65) are executed.

(F. Modifications)

Although the preferred embodiment of the present invention has been described above, the present invention is not limited to the above description.

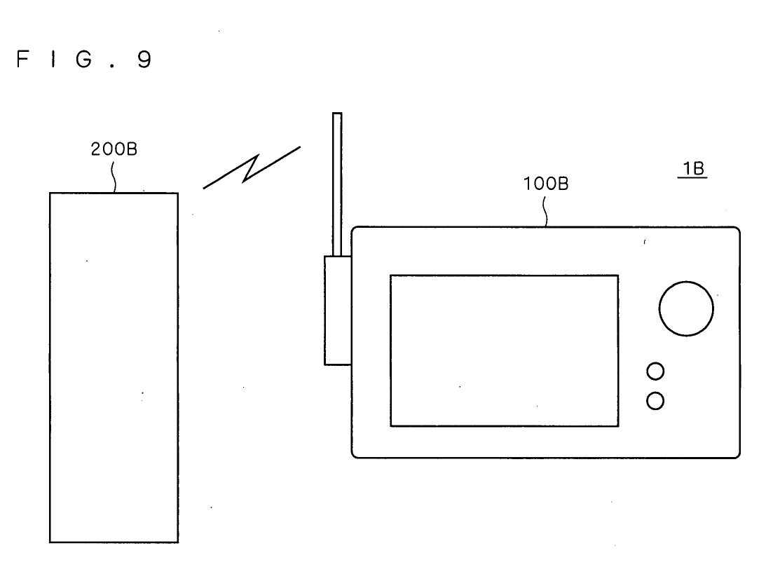

For example, in the aforementioned preferred embodiment, when it is determined that the recording setting exceeds the recording capability (picture recording capability) of the memory card 9, the recording setting is changed by the operator or the memory card is replaced (step SP24 in FIG. 4 and the like). However, the present invention is not limited to the embodiment. FIG. 8 is a flowchart which illustrates operations according to a modification. Concretely, as illustrated in FIG. 8, when it is determined in step SP22 that the present recording setting exceeds the recording capability (image recording capability) of the memory card 9, the recording setting may be automatically changed (steps SP27 and SP26). More specifically, when the present recording setting exceeds the recording capability (image recording capability) of the memory card 9, the recording resolution in the recording setting is changed from the original value (e.g., “320×240 pixels”) to a lower value (e.g., “160×120 pixels”) so that the recording setting does not exceed the recording capability (step SP27). In step SP26, the cradle 200A sets the output resolution of an image output toward the digital camera 100A to the same value as the resolution (set value) PR in moving image recording. With this configuration, without converting resolution in the digital camera 100A, recording can be properly performed on the memory card 9.

Although it is not illustrated in FIG. 8, in the case where there is still a problem in recording to the memory card 9 even after the recording setting is automatically changed (step SP27), a warning may be displayed on the LCD 5 to encourage the operator to replace the memory card 9.

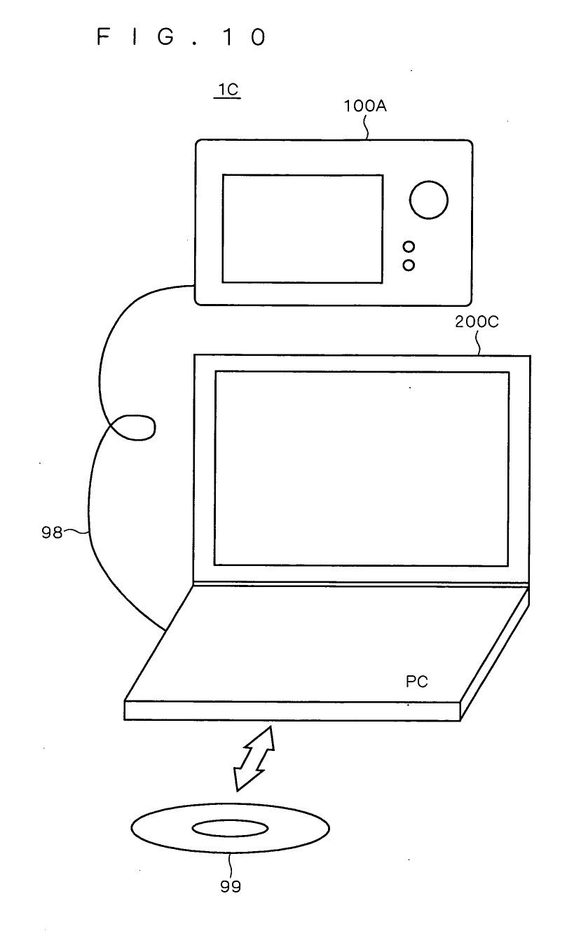

Although the case where the cradle 200A on which the digital camera 100A is placed has the TV broadcast receiving function and the like, in short, the case where the digital camera 100A and the cradle 200A are connected to each other via a wire has been described above in the aforementioned preferred embodiment, the present invention is not limited to the case. Concretely, as illustrated in FIG. 9, a digital camera 100B may be provided in place of the digital camera 100A and a TV unit 200B may be provided in place of the cradle 200A. FIG. 9 illustrates a system 1B as such a modification.

The digital camera 100B has a configuration similar to that of the digital camera 100A, and the TV unit 200B has a configuration similar to that of the cradle 200A. Each of the digital camera 100B and the TV unit 200B employs a wireless LAN as an external connection interface. The TV unit 200B has a TV broadcast receiving function and the like similar to that of the cradle 200A, and the TV unit 200B and the digital camera 100B are connected to each other via radio communications. The TV unit 200B transfers a received TV image in a state where the resolution is converted (lowered) to the digital camera 100B via the wireless LAN. The configuration can obtain effects similar to those of the aforementioned preferred embodiment except for the charging function.

Alternatively, as illustrated in FIG. 10, the function of the cradle 200A may be realized by using a personal computer 200C. The personal computer 200C realizes operations similar to those of the cradle 200A by executing a predetermined program. FIG. 10 illustrates a system 1C of such a modification. The predetermined program may be provided in a state where it is recorded on a recording medium such as a CD-ROM or may be provided by a downloading operation via a network such as the Internet.

The personal computer 200C has a TV tuner unit or the like and has the function of transferring a received TV image to the digital camera 100A via a USB cable 98 in a state where the resolution of the image is converted (lowered). The personal computer 200C can also reproduce a DVD 99 and also has a function of transferring an image reproduced from the DVD 99 via the USB cable 98 in a state where the resolution of the image is converted (lowered).

Although the case where display of a TV image is finished in response to a finishing instruction (step SP16) by the operator in FIG. 4 has been described in the aforementioned preferred embodiment, the present invention is not limited to the embodiment. For example, it is also possible to execute the process of step SP21 (to step SP25) before step SP13, in the case where it is found that recording programming exists, finish displaying a TV image just before (e.g., one minute before) the recording start time of the recording programming, and forcedly shift to a recording state (step SP37).

Although the case of setting recording programming by using the digital camera 100A has been described in the aforementioned preferred embodiment, the present invention is not limited to thereto. Alternatively, recording programming may be set by using an image output apparatus (e.g., the cradle 200A, TV unit 200B or personal computer 200C). More specifically, an electronic program table is displayed in the personal computer 200C and recording programming may be performed by using the electronic program table.

Although the case where displaying and recording of an external input image (such as TV image) are not simultaneously performed is assumed in the aforementioned preferred embodiment in order to simplify the description, the present invention is not limited to the case. Displaying and recording of an external input picture may be performed simultaneously. In this case, it is preferable not to output sound from the speaker 36 of the digital camera 100A (it is preferable to mute) at the time of programmed recording. Concretely, it is sufficient for the digital camera 100A to stop outputting sound at the time of programmed recording. Alternatively, it is sufficient to transmit a control instruction of stopping sound output from the cradle 200A to the digital camera 100A at the time of programmed recording. By stopping sound output from the speaker 36 at the time of programmed recording, unintentional output of sound from the speaker 36 when recording starts (particularly, in the night or the like) can be prevented.

Although the case of selecting recording resolution from plural set values has been described in the aforementioned preferred embodiment, the present invention is not limited to the case. The recording resolution may be automatically set to the same resolution as that of the LCD 5.

Although the case where a TV broadcast signal is an analog signal is assumed in the aforementioned preferred embodiment, the present invention is not limited to the case. Concretely, the idea can be also applied to the case where a digital broadcast program is received. More specifically, the resolution of a received image (TV image) of a digital broadcast is converted to the display distribution of the LCD 5 in the cradle 200A and, after that, the resultant image is transferred from the cradle 200A to the digital camera 100A.

While the invention has been shown and described in detail, the foregoing description is in all aspects illustrative and not restrictive. It is therefore understood that numerous modifications and variations can be devised without departing from the scope of the invention.

What is claimed is:

1. An image output apparatus for outputting an image to an image capturing apparatus, comprising:
a first acquisition part for acquiring information concerning a display resolution of a display of said image capturing apparatus;
a change part for changing an output resolution of said image in accordance with said display resolution; and
an output part for outputting said image with said output resolution changed by said change part to said image capturing apparatus, wherein
said change part changes said output resolution to a resolution lower than an original resolution of said image.

2. The image output apparatus according to claim 1, wherein
said first acquisition part acquires information concerning said display resolution by communication with said image capturing apparatus.

3. The image output apparatus according to claim 1, wherein
said image is a moving image.

4. The image output apparatus according to claim 1, further comprising:
a second acquisition part for acquiring an image recording capability of a recording part in said image capturing apparatus; and
a setting part for making a recording setting in said recording part, wherein
said setting part changes a recording resolution in said recording setting so that said recording setting does not exceed said image recording capability, and
said change part changes said output resolution to the same resolution as said recording resolution changed by said setting part.

5. The image output apparatus according to claim 1, further comprising:
a power supply part for supplying power to said image capturing apparatus.

6. The image output apparatus according to claim 5, wherein
said power supply part can charge a battery of said image capturing apparatus and, at least, at the time of recording said image by said image capturing apparatus, does not charge said battery.

7. The image output apparatus according to claim 1, further comprising:
a programming part for programming recording of said image in said image capturing apparatus.

8. The image output apparatus according to claim 1, wherein
said change part changes said output resolution of said image in accordance with an unused storage capacity in a recording part in said image capturing apparatus and a recording time in a programmed recording.

9. The image output apparatus according to claim 1, further comprising:
a controller for controlling said image capturing apparatus so as not to output sound from a speaker of said image capturing apparatus during programmed recording in said image capturing apparatus.

10. The image output apparatus according to claim 1, further comprising:
an information addition part, in the case where an output image from said image output apparatus is recorded by said image capturing apparatus and a recording file is generated, for adding information indicating that the image is a recorded image obtained by recording the output image from said image output apparatus to said recording file.

11. A program product recording a program making a computer output an image to an image capturing apparatus, said program product including instructions of:
a) acquiring information concerning a display resolution of a display of said image capturing apparatus;
b) changing an output resolution of said image in accordance with said display resolution; and
c) outputting said image with said output resolution changed by said instruction b) to said image capturing apparatus, wherein
said instruction b) has an instruction of changing said output resolution to a resolution lower than an original resolution of said image.

12. The program product according to claim 11, wherein
said instruction a) includes an instruction of acquiring information concerning said display resolution by communication with said image capturing apparatus.

13. The program product according to claim 11, wherein
said image is a moving image.

14. The program product according to claim 11, further including instructions of:
d) acquiring an image recording capability in a recording part of said image capturing apparatus; and
e) making a recording setting in said recording part, wherein
said instruction e) includes an instruction of changing a recording resolution in said recording setting so that said recording setting does not exceed said image recording capability, and
said instruction b) includes an instruction of changing said output resolution to the same as said recording resolution changed by said instruction e).

15. An image input/output system comprising:
an image capturing apparatus; and
an image output apparatus for outputting an image to the image capturing apparatus, wherein
the image output apparatus comprises:
a first acquisition part for acquiring information concerning a display resolution of a display of said image capturing apparatus;
a change part for changing an output resolution of said image in accordance with said display resolution; and
an output part for outputting said image with said output resolution changed by said change part to said image capturing apparatus, and
said change part changes said output resolution to a resolution lower than an original resolution of said image.

16. The image input/output system according to claim 15, wherein
said first acquisition part acquires information concerning said display resolution by communication with said image capturing apparatus.

17. The image input/output system according to claim 15, wherein
said image is a moving image.

18. The image input/output system according to claim 15, wherein
the image output apparatus further comprises:
a second acquisition part for acquiring an image recording capability of a recording part in said image capturing apparatus; and
a setting part for making a recording setting in said recording part,
said setting part changes a recording resolution in said recording setting so that said recording setting does not exceed said image recording capability, and
said change part changes said output resolution to the same resolution as said recording resolution changed by said setting part.

19. An image capturing apparatus comprising:
a display for reproducing and displaying an image;
a speaker capable of outputting sound related to said image; and
a controller for determining whether an image to be reproduced is an image captured by the image capturing apparatus or a recorded image obtained by recording an image input to the image capturing apparatus and, when said image to be reproduced is determined as said recorded image, performing control so as not to output a sound output related to said image to be reproduced from said speaker.
